(19) United States
(12) Patent Application Publication
(10) Pub. No.: US 2024/0268594 A1
(43) Pub. Date: Aug. 15, 2024

(54) FRUIT AND VEGETABLE JUICER CAPABLE OF CUTTING FRUITS AND VEGETABLES IN THREE-DIMENSIONALLY UP-AND-DOWN CUTTING MANNER

(71) Applicant: GOLDEN PINEAPPLE GRINDER CO., LTD., NEW TAIPEI CITY (TW)

(72) Inventor: RONG-YUAN TSENG, NEW TAIPEI CITY (TW)

(21) Appl. No.: 18/416,076

(22) Filed: Jan. 18, 2024

(30) Foreign Application Priority Data
Feb. 10, 2023 (TW) 112104775

(51) Int. Cl. A47J 19/02; A47J 19/06

(52) U.S. Cl. CPC A47J 19/027; A47J 19/06

(57) ABSTRACT

A fruit and vegetable juicer contains: a first holder, a second holder, a filtration mesh, a cutter assembly, and a cap. The second holder includes a drive shaft configured to connect with the cutter assembly so that the cutter assembly rotates at a high speed to cut fruits and vegetables which are fed from an inlet of the cap. The cutter assembly includes a first cutting disc and a second cutting disc. The first cutting disc has a toothed layer surrounding around a peripheral side thereof, a circular orifice defined on a central portion of the first cutting disc, and multiple spaced recesses. The second cutting disc has multiple central teeth, multiple toothed rows radially extending outward from the multiple central teeth, the toothed layer radially extending inward around a peripheral side of the second cutting disc, and the multiple spaced cutouts.

### TECHNICAL FIELD

The present disclosure relates to a fruit and vegetable juicer, and more particularly to the fruit and vegetable juicer is capable of cut the fruits and vegetables into particles finely in a three-dimensionally up-and-down cutting manner, thus enhancing juicing yield effectively.

### BACKGROUND

Referring to FIG. 1, a conventional fruit and vegetable juicer 1 has been disclosed by the inventor of the present invention in TW Utility Model No. 493417, and the conventional fruit and vegetable juicer contains: a first holder 11, a second holder 12, and a cap 13. The first holder 11 has a drive shaft 111 driven by a motor (not shown) and configured to connect the second holder 12 with the first holder 11, such that after a cutter assembly 14 which is a plane is fitted with a filtration mesh 15, the cutter assembly 14 is locked on the drive shaft 111. The cap 13 has an inlet 131 defined on a side thereof, and a pomace bucket 17 is connected on the other side of the cap 13. Thereby, after the fruits and the vegetables are fed into the conventional fruit and vegetable juicer 1 from the inlet 131, the fruits and the vegetables are rotatably cut by the cutter assembly 14 at a high speed to separate pomace from juices of the fruits and the vegetables, wherein the juices are discharged out of an outlet 121, and the pomace is thrown into the pomace bucket 17. However, such a conventional fruit and vegetable juicer has defects as follows:
1) Particles the fruits and the vegetables are cut by cutter assembly 14 in different sizes, wherein the larger the sizes of the particles is, the worse the juicing yield of the fruits and vegetable juice is, thus obtaining a poor juicing yield.
2) The cutter assembly 14 separates the pomace from the juice by using a rotatable centrifugal force at the high speed, so the particles are thrown into the pomace bucket 17 when not being cut to produce the juice completely, thus producing a juicing waste and decreasing a juicing yield.

The present invention has arisen to mitigate and/or obviate the afore-described disadvantages.

### SUMMARY

A primary aspect of the present invention is to provide a fruit and vegetable juicer is capable of cut the fruits and vegetables into particles finely in a three-dimensionally up-and-down cutting manner, thus enhancing juicing yield effectively

To obtain above-mentioned aspect, a fruit and vegetable juicer provided by the present invention contains: a first holder, a second holder, a filtration mesh, a cutter assembly, and a cap. The second holder including a drive shaft configured to connect with the cutter assembly, such that the cutter assembly rotates at a high speed to cut fruits and vegetables which are fed from an inlet of the cap, thus cutting and juicing the fruits and vegetables.

The cutter assembly includes a first cutting disc and a second cutting disc connected on the first cutting disc to obtain an up-and-down three-dimensional cutting mode, the first cutting disc has a toothed layer surrounding around a peripheral side thereof, and the second cutting disc has a toothed layer radially extending inward around a peripheral side thereof, such that the fruits and vegetables are cut into particles finely and repeatedly by using the toothed layer of the first cutting disc and the toothed layer of the second cutting disc, thus obtaining an outstanding juicing yield.

Preferably, the first cutting disc of the cutter assembly includes has a toothed layer surrounding around a peripheral side thereof, a circular orifice defined on a central portion thereof, and multiple tilted teeth formed around an inner wall of the circular orifice, wherein a respective one tilted teeth has a beveled face. The second cutting disc has multiple central teeth, multiple toothed rows radially extending outward from the multiple central teeth, and a toothed layer radially extending inward around a peripheral side of the second cutting disc. Thereby, the fruits and vegetables are cut and juiced at a first time by using the first cutting disc and the second cutting disc. The toothed layer corresponds to the toothed layer of the first cutting disc so as to further cut the fruits and vegetables into the particles finely in a three-dimensionally up-and-down cutting manner, thus cutting and juicing the fruits and vegetables completely.

In a preferred embodiment, the first cutting disc further has a cut fence vertically extending around the peripheral side thereof and having a toothed portion formed on the cut fence, such that a slit is defined among the cut fence of the first cutting disc and multiple peripheral teeth of the second cutting disc so that particles are cut and juiced further on the multiple tilted teeth. The first cutting disc has a groove defined on a predetermined position of the cut fence configures to discharge pomace of the fruits and vegetables out of the groove.

In another preferred embodiment, the first cutting disc further has a cut fence vertically extending around the peripheral side thereof and having a toothed portion formed on the cut fence, the first cutting disc further has multiple spaced grooves, and each spaced groove is defined between any two adjacent cut fences, such that the pomace of the fruits and vegetables is discharged effectively.

The first cutting disc also has multiple spaced recesses obliquely extending among the toothed layer and the multiple tilted teeth of the first cutting disc, wherein particles generating by cutting the fruits and vegetables at the first time are guided by the multiple tilted teeth and are received among the multiple spaced recesses of the first cutting disc and multiple spaced cutouts of the second cutting disc. The toothed layer of the first cutting disc corresponds to the toothed layer of the second cutting disc so that the fruits and vegetables are cut finely by the peripheral sides of the multiple spaced recesses and the multiple spaced cutouts, thus juicing the fruits and vegetables completely.

A width of the toothed layer of the first cutting disc and a width the toothed layer of the second cutting are increased so as to cut the fruits and vegetables completely to enhance the juicing yield, after the fruits and vegetables move into the toothed layers of the first cutting disc and the second cutting disc.

The multiple spaced recesses of the first cutting disc and the multiple spaced cutouts of the second cutting disc has different depths so that the particles are rotatably cut finely by the multiple spaced recesses of the first cutting disc and the multiple spaced cutouts of the second cutting disc, thus cutting and juicing the particles to enhance the juicing yield.

Other objects and features will be in part apparent and in part pointed out hereinafter.

### BRIEF DESCRIPTION OF THE DRAWINGS

FIG. 1 is a perspective view showing the exploded components of a conventional fruit and vegetable juicer.

FIG. 2 is a perspective view showing the exploded components of a fruit and vegetable juicer according to the present invention.

FIG. 3 is a perspective view showing the assembly of the fruit and vegetable juicer according to a first embodiment of the present invention.

FIG. 4 is a side plan view of the assembly of the cutter assembly of the fruit and vegetable juicer according to the first embodiment of the present invention.

FIG. 5 is a perspective view showing the assembly of the first cutting disc of the fruit and vegetable juicer according to the first embodiment of the present invention.

FIG. 6 is a perspective view showing the assembly of the second cutting disc of the fruit and vegetable juicer according to the first embodiment of the present invention.

FIG. 7 is a cross sectional view showing the assembly of a part of the cutter assembly of the fruit and vegetable juicer according to the first embodiment of the present invention.

FIG. 8 is a perspective view showing the assembly of a cutter assembly of a fruit and vegetable juicer according to a second embodiment of the present invention.

FIG. 9 is a side plan view of the assembly of the cutter assembly of the fruit and vegetable juicer according to the second embodiment of the present invention.

FIG. 10 is a perspective view showing the assembly of a first cutting disc of the fruit and vegetable juicer according to the second embodiment of the present invention.

FIG. 11 is a perspective view showing the assembly of a second cutting disc of the fruit and vegetable juicer according to the second embodiment of the present invention.

FIG. 12 is a perspective view showing the assembly of a cutter assembly of a fruit and vegetable juicer according to a third embodiment of the present invention.

FIG. 13 is a side plan view of the assembly of a first cutting disc of the fruit and vegetable juicer according to the third embodiment of the present invention.

FIG. 14 is a perspective view showing the assembly of the first cutting disc of the fruit and vegetable juicer according to the third embodiment of the present invention.

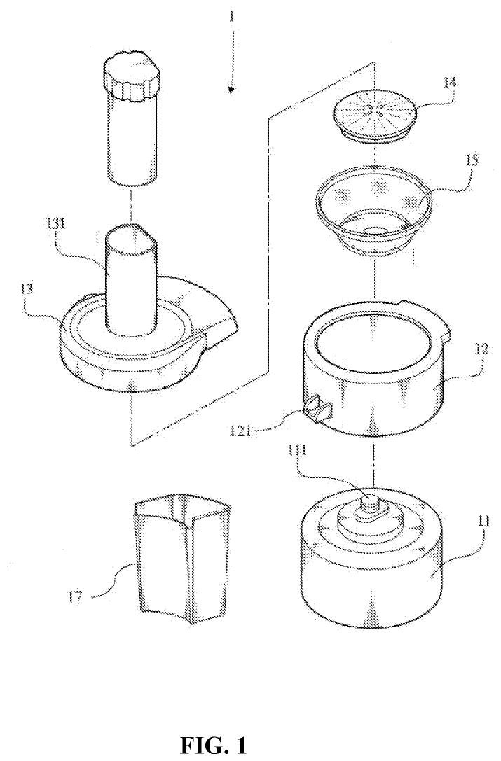

### DETAILED DESCRIPTION

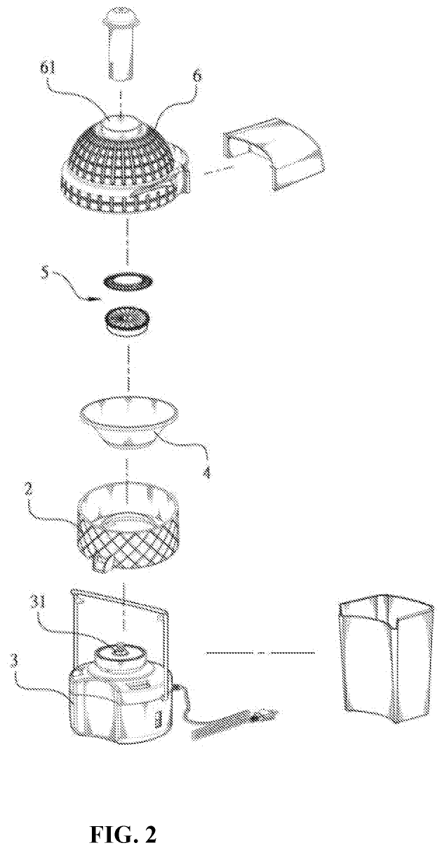

FIG. 2 is a perspective view showing the exploded components of a fruit and vegetable juicer according to the present invention. The fruit and vegetable juicer comprises: a first holder 2, a second holder 3, a filtration mesh 4, a cutter assembly 5, and a cap 6. The second holder 3 includes a drive shaft 31 configured to connect with the cutter assembly 5 so that the cutter assembly 5 rotates at a high speed to cut fruits and vegetables which are fed from an inlet 61 of the cap 6, thus juicing the fruits and vegetables. The cutter assembly 5 includes a first cutting disc and a second cutting disc connected on the first cutting disc to obtain an up-and-down three-dimensional cutting mode, wherein each of the first cutting disc and the second cutting disc has a toothed layer.

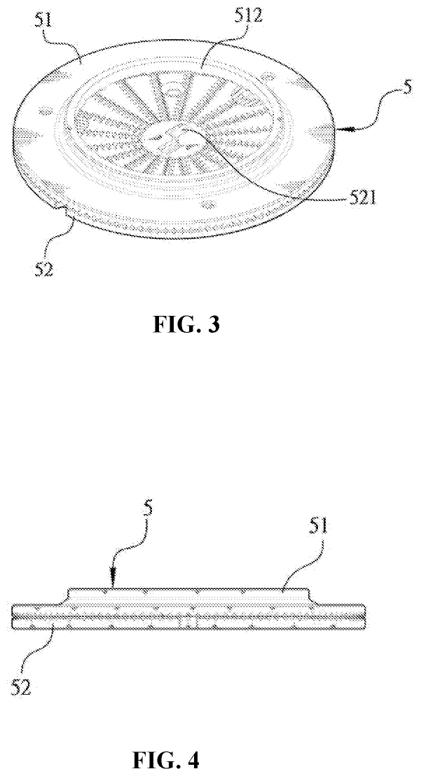

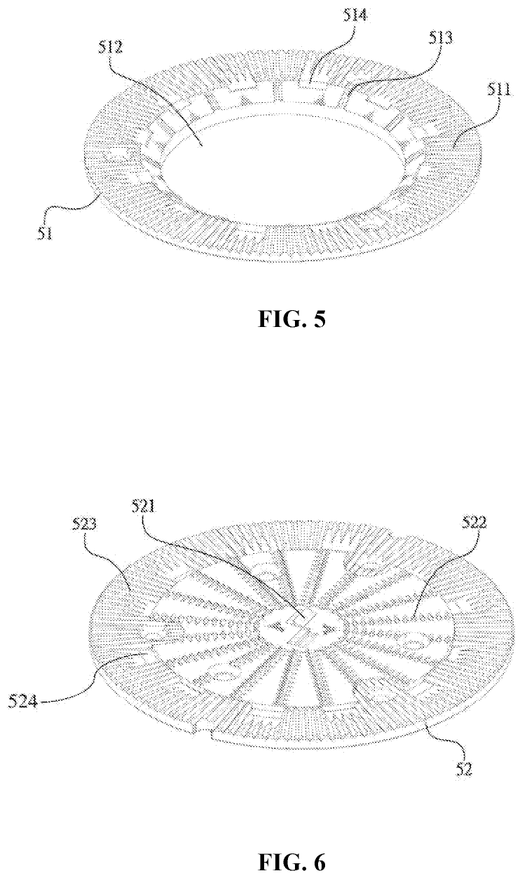

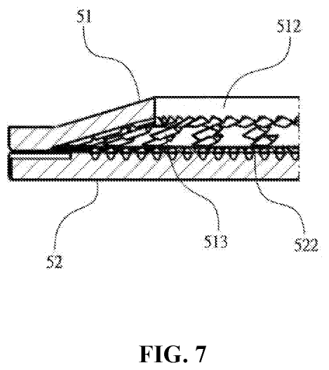

FIG. 3 is a perspective view showing the assembly of the cutter assembly of the fruit and vegetable juicer according to a first embodiment of the present invention. FIG. 4 is a side plan view of the assembly of the cutter assembly of the fruit and vegetable juicer according to the first embodiment of the present invention. FIG. 5 is a perspective view showing the assembly of the first cutting disc of the fruit and vegetable juicer according to the first embodiment of the present invention. FIG. 6 is a perspective view showing the assembly of the second cutting disc of the fruit and vegetable juicer according to the first embodiment of the present invention. FIG. 7 is a cross sectional view showing the assembly of a part of the cutter assembly of the fruit and vegetable juicer according to the first embodiment of the present invention. The cutter assembly 5 includes a first cutting disc 51 and a second cutting disc 52, wherein the first cutting disc 51 has a toothed layer 511 surrounding around a peripheral side thereof, a circular orifice 512 defined on a central portion thereof, and multiple tilted teeth 513 formed around an inner wall of the circular orifice 512 and configured to guide the fruits and vegetables to be cut and juiced more finely after being cut at first time. The first cutting disc 51 also has multiple spaced recesses 514 obliquely extending among the toothed layer 511 and the multiple tilted teeth 513, wherein particles generating by cutting the fruits and vegetables at the first time are guided by the multiple tilted teeth 513 and are received among the multiple spaced recesses 514 and multiple spaced cutouts 524 of the second cutting disc 52, such that when the second cutting disc 52 rotates, the fruits and vegetables are cut finely by peripheral sides of the multiple spaced recesses 514 and the multiple spaced cutouts 524 to move into a slit between the toothed layer 511 of the first cutting disc 51 and the toothed layer 523 of the second cutting disc 52, thus cutting and juicing the particles at a second time. The multiple tilted teeth 513 are arranged separately to move the particles from the multiple tilted teeth 51 into the slit between the toothed layer 511 and the toothed layer 523 of the second cutting disc 52, wherein a respective one tilted teeth 513 has a beveled face configured to produce a centrifugal force to throw and juice the particles outward.

The second cutting disc 52 has multiple central teeth 521, multiple toothed rows 522 radially extending outward from the multiple central teeth 521 and configured to cut and juice the fruits and vegetables at the first time, the toothed layer 523 radially extending inward around a peripheral side of the second cutting disc 52, and the multiple spaced cutouts 524 defined among the multiple toothed rows 522 and the toothed layer 523. The toothed layer 523 corresponds to the toothed layer 511 of the first cutting disc 51 so as to cut the fruits and vegetables into the particles finely at the second time in a three-dimensionally up-and-down cutting manner. The multiple spaced cutouts 524 of the second cutting disc 52 correspond to the multiple spaced recesses 514 of the first cutting disc 51 so that when the second cutting disc 52 rotates, the fruits and vegetables are cut finely by the peripheral sides of the multiple spaced recesses 514 and the multiple spaced cutouts 524 to move into the slit between the toothed layer 511 of the first cutting disc 51 and the toothed layer 523 of the second cutting disc 52, thus cutting and juicing the particles at the second time.

Since a size of the particles after being cut at the first time is more than a size of the slit between the toothed layer 511 of the first cutting disc 51 and the toothed layer 523 of the second cutting disc 52, the particles are guided by the multiple tilted teeth 513 and are rotatably cut by the multiple spaced recesses 514 of the first cutting disc 51 and the multiple spaced cutouts 524 of the second cutting disc 52 to move into the slit between the toothed layer 511 of the first cutting disc 51 and the toothed layer 523 of the second cutting disc 52, thus cutting and juicing the particles at the second time.

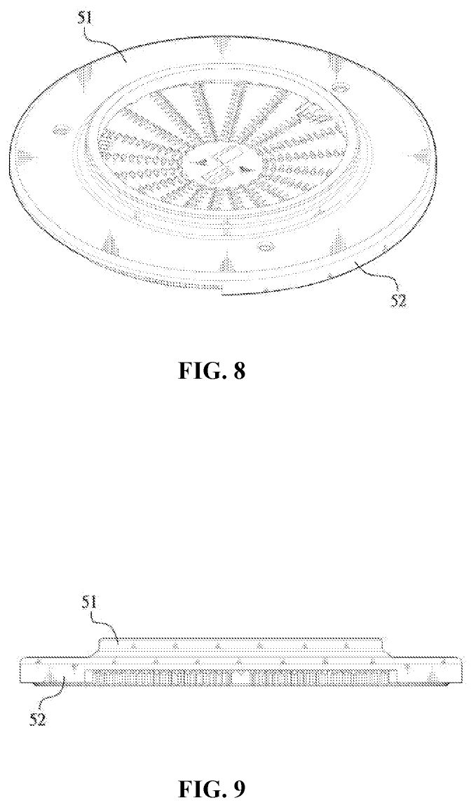

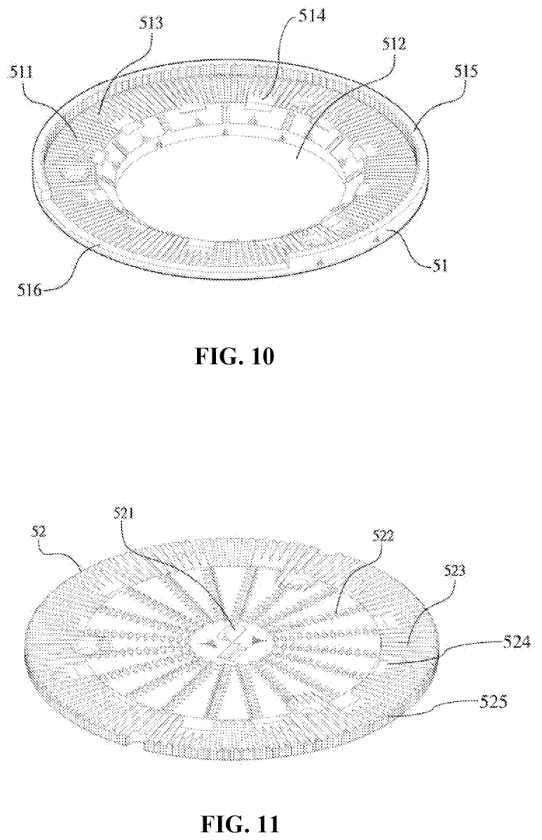

FIG. 8 is a perspective view showing the assembly of a cutter assembly of a fruit and vegetable juicer according to a second embodiment of the present invention. FIG. 9 is a side plan view of the assembly of the cutter assembly of the fruit and vegetable juicer according to the second embodiment of the present invention. FIG. 10 is a perspective view showing the assembly of a first cutting disc of the fruit and vegetable juicer according to the second embodiment of the present invention. FIG. 11 is a perspective view showing the assembly of a second cutting disc of the fruit and vegetable juicer according to the second embodiment of the present invention. In the second embodiment, the first cutting disc 51 has a toothed layer 511 surrounding around a peripheral side thereof, a circular orifice 512 defined on a central portion thereof, multiple tilted teeth 513 formed around an inner wall of the circular orifice 512, and multiple spaced recesses 514, wherein the first cutting disc 51 further has a cut fence 515 vertically extending around the peripheral side thereof and having a toothed portion formed on the cut fence 515, and the first cutting disc 51 has a groove 516 defined on a predetermined position of the cut fence 515, such that a slit is defined among the cut fence 515 of the first cutting disc 51 and multiple peripheral teeth 525 of the second cutting disc 52 so that particles are cut and juiced at a third time by using the cut fence 515, after moving through the toothed layer 511 and the multiple peripheral teeth 525. Thereafter, pomace of the fruits and vegetables are discharge out of the groove 516.

Referring to FIG. 11, in the second embodiment, the second cutting disc 52 has multiple central teeth 521, multiple toothed rows 522 radially extending outward from the multiple central teeth 521, and the multiple spaced cutouts 524 defined among the multiple toothed rows 522 and the toothed layer 523 so as to cut and juice the fruits and vegetables. The toothed layer 523 corresponds to the toothed layer 511 of the first cutting disc 51 to cut the fruits and vegetables into the particles finely at a second time in a three-dimensionally up-and-down cutting manner. The second cutting disc 52 further has the multiple peripheral teeth 525 formed on a peripheral side thereof and corresponding to the cut fence 515 of the first cutting disc 51 to cut and juice the particles at the third time.

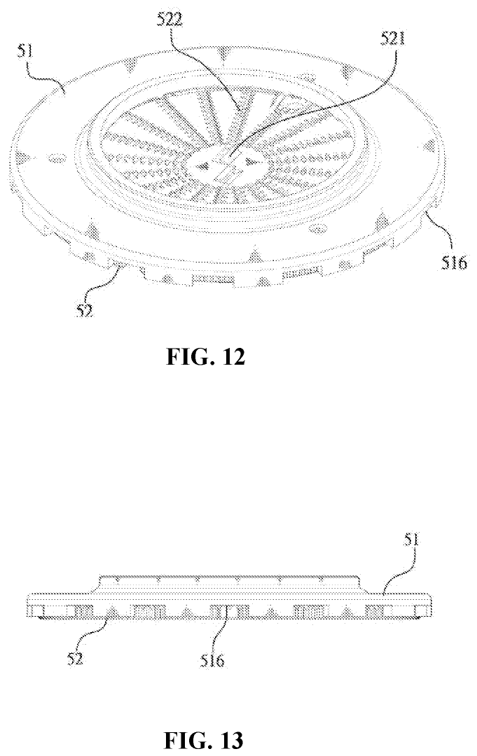

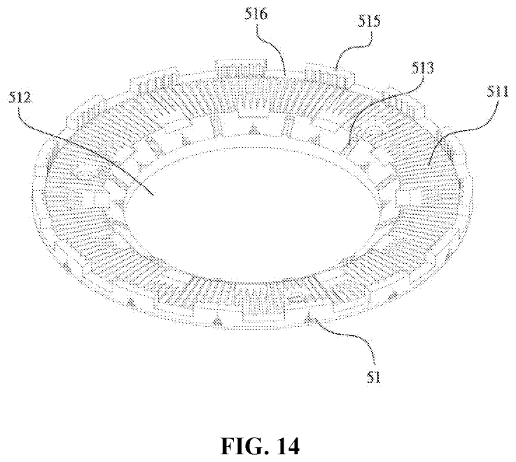

FIG. 12 is a perspective view showing the assembly of a cutter assembly of a fruit and vegetable juicer according to a third embodiment of the present invention. FIG. 13 is a side plan view of the assembly of a first cutting disc of the fruit and vegetable juicer according to the third embodiment of the present invention. FIG. 14 is a perspective view showing the assembly of the first cutting disc of the fruit and vegetable juicer according to the third embodiment of the present invention. As shown in FIG. 13, the cutter assembly of the third embodiment includes the first cutting disc 51, and the first cutting disc 51 has multiple cut fences 515 vertically extending around a peripheral side thereof, wherein each fence 515 has a toothed portion formed thereon, the first cutting disc 51 further has multiple spaced grooves 516, and each spaced groove 516 is defined between any two adjacent cut fences 515, such that a slit is defined among the multiple cut fences 515 of the first cutting disc 51 and multiple peripheral teeth 525 of the second cutting disc 52 so that particles are cut and juiced further in the slit. Referring to FIG. 11, the second cutting disc 52 has multiple central teeth 521, multiple toothed rows 522 radially extending outward from the multiple central teeth 521, the toothed layer 523 radially extending inward around a peripheral side of the second cutting disc 52, and the multiple spaced cutouts 524, such that the fruits and the vegetables are cut and juiced at the first time. The toothed layer 523 corresponds to the toothed layer 511 of the first cutting disc 51 so as to cut the fruits and vegetables into the particles finely at a second time in a three-dimensionally up-and-down cutting manner. The second cutting disc 52 further has the multiple peripheral teeth 525 formed on the peripheral side thereof and corresponding to the cut fence 515 of the first cutting disc 51 to cut and juice the particles at the third time.

In a fourth embodiment, the cutter assembly includes a toothed layer 511 of a first cutting disc 51 and a toothed layer 523 of the second cutting disc 52, wherein a size and a width of the toothed layer 511 and the toothed layer 523 are increased more than a size and a width of the toothed layer 511 and toothed layer 523 of the first embodiment. The toothed layer 511 has multiple spaced recesses 514, and the toothed layer 523 of the second cutting disc 52 has multiple spaced cutouts 524, such that the fruits and vegetables are moved and cut easily by using the multiple spaced recesses 514 and the multiple spaced cutouts 524, and the fruits and vegetables are further moved to the multiple tilted teeth 513 and the multiple toothed rows 522, thus cutting and juicing the fruits and vegetables effectively.

As illustrated in a Table First as follows, a result of an experiment is listed in the Table First to show a juicing yield of the fruit and vegetable juicer of the present invention:

TABLE FIRST

| | P brand | | | The present invention | | |
|---|---|---|---|---|---|---|
| | Net | | Juicing | Net | | Juicing |
| | weight | Juice | yield | weight | Juice | yield |
| | (g) | (g) | (%) | (g) | (g) | (%) |
| cabbage | 1260 | 719 | 57.1% | 1260 | 831 | 68.4% |
| cabbage | 1710 | 938 | 54.9% | 1710 | 1187 | 69.4% |
| cabbage | 1581 | 867 | 54.8% | 1593 | 1208 | 75.8% |
| cabbage | 1216 | 637 | 52.4% | 2398 | 1794 | 74.8% |
| cabbage | 1610 | 900 | 55.9% | 1585 | 1111 | 70.4% |
| carrot | 1354 | 675 | 49.50% | 1353 | 911 | 67.3% |
| carrot | 1345 | 701 | 52.10% | 1345 | 922 | 68.6% |
| carrot | 1470 | 787 | 53.50% | 1470 | 945 | 64.3% |
| carrot | 1157 | 666 | 57.56% | 1464 | 948 | 64.8% |
| carrot | 1213 | 640 | 52.8% | 1093 | 668 | 61.1% |
| carrot | 1341 | 720 | 53.6% | 1009 | 624 | 61.8% |
| grape | 465 | 307 | 66.0% | 464 | 375 | 80.8% |
| grape | 513 | 351 | 68.4% | 513 | 421 | 82.1% |
| grape | 500 | 341 | 68.2% | 500 | 392 | 78.4% |
| grape | 827 | 484 | 58.5% | 560 | 440 | 78.6% |
| grape | 515 | 339 | 65.8% | 540 | 421 | 78.1% |
| momordica | 1447 | 917 | 63.4% | 1448 | 1040 | 71.8% |
| charantia | | | | | | |
| momordica | 874 | 538 | 61.6% | 873 | 620 | 71.0% |
| charantia | | | | | | |
| momordica | 1032 | 664 | 64.3% | 1032 | 740 | 71.7% |
| charantia | | | | | | |
| momordica | 1109 | 715 | 64.5% | 1017 | 731 | 71.8% |
| charantia | | | | | | |
| momordica | 1636 | 1041 | 63.6% | 1291 | 945 | 73.2% |
| charantia | | | | | | |

Thereby, the fruit and vegetable juicer includes the toothed layers, the multiple tilted teeth, and the multiple spaced recesses of the first cutting disc, the multiple toothed rows, the toothed layer, and multiple spaced cutouts of the second cutting disc which match with the first holder, the second holder, and the filtration mesh so as to cut the fruits and vegetables in the three-dimensionally up-and-down cutting manner, thus cutting the fruits and vegetables into particles finely to enhance juicing yield effectively.

Having described the invention in detail, it will be apparent that modifications and variations are possible without departing from the scope of the invention defined in the appended claims.

When introducing elements of the present invention or the preferred embodiments thereof, the articles “a”, “an”, “the” and “said” are intended to mean that there are one or more of the elements. The terms “comprising”, “including” and “having” are intended to be inclusive and mean that there may be additional elements other than the listed elements.

In view of the above, it will be seen that the several objects of the invention are achieved and other advantageous results attained.

As various changes could be made in the above constructions, products, and methods without departing from the scope of the invention, it is intended that all matter contained in the above description and shown in the accompanying drawings shall be interpreted as illustrative and not in a limiting sense.

What is claimed is:

1. A fruit and vegetable juicer comprising: a first holder, a second holder, a filtration mesh, a cutter assembly, and a cap, the second holder including a drive shaft configured to connect with the cutter assembly so that the cutter assembly rotates at a high speed to cut fruits and vegetables which are fed from an inlet of the cap, thus juicing the fruits and vegetables;
wherein the cutter assembly includes a first cutting disc and a second cutting disc, the first cutting disc has a toothed layer surrounding around a peripheral side thereof, a circular orifice defined on a central portion of the first cutting disc, and multiple spaced recesses extending on the first cutting disc; and
wherein the second cutting disc has multiple central teeth, multiple toothed rows radially extending outward from the multiple central teeth, a toothed layer radially extending inward around a peripheral side of the second cutting disc, and the multiple spaced cutouts defined on the second cutting disc.

2. The fruit and vegetable juicer as claimed in claim 1, wherein the first cutting disc has multiple tilted teeth formed around an inner wall of the circular orifice, and a respective one tilted teeth has a beveled face.

3. The fruit and vegetable juicer as claimed in claim 1, wherein the first cutting disc further has at least one cut fence vertically extending around the peripheral side thereof and having a toothed portion formed on the at least one cut fence, and the first cutting disc has at least one groove defined on a predetermined position of the at least one cut fence, such that a slit is defined among the at least one cut fence of the first cutting disc and multiple peripheral teeth of the second cutting disc so that particles generating by cutting the fruits and vegetables are cut and juiced further by using the at least one cut fence.

4. The fruit and vegetable juicer as claimed in claim 2, wherein the first cutting disc further has at least one cut fence vertically extending around the peripheral side thereof and having a toothed portion formed on the at least one cut fence, and the first cutting disc has at least one groove defined on a predetermined position of the at least one cut fence, such that a slit is defined among the at least one cut fence of the first cutting disc and multiple peripheral teeth of the second cutting disc so that particles generating by cutting the fruits and vegetables are cut and juiced further by using the at least one cut fence.

5. The fruit and vegetable juicer as claimed in claim 3, wherein the first cutting disc has multiple spaced grooves, and each spaced groove is defined between any two adjacent cut fences.

6. The fruit and vegetable juicer as claimed in claim 4, wherein the first cutting disc has multiple spaced grooves, and each spaced groove is defined between any two adjacent cut fences.

7. The fruit and vegetable juicer as claimed in claim 1, wherein a width of the toothed layer of the first cutting disc and a width the toothed layer of the second cutting are increased so as to move and cut the fruits and vegetables effectively.

8. The fruit and vegetable juicer as claimed in claim 2, wherein a width of the toothed layer of the first cutting disc and a width the toothed layer of the second cutting are increased so as to move and cut the fruits and vegetables effectively.

9. The fruit and vegetable juicer as claimed in claim 1, wherein the multiple spaced recesses of the first cutting disc and the multiple spaced cutouts of the second cutting disc has different depths.

10. The fruit and vegetable juicer as claimed in claim 2, wherein the multiple spaced recesses of the first cutting disc and the multiple spaced cutouts of the second cutting disc has different depths.
